(19) United States
(12) Patent Application Publication
(10) Pub. No.: US 2007/0282040 A1
(43) Pub. Date: Dec. 6, 2007

(54) POLYESTER, POLYCARBONATE AND POLYAMIDE BLENDS AND ARTICLES HAVING ENHANCED BALANCE OF GLOW WIRE IGNITION TEMPERATURE, COMPARATIVE TRACKING INDEX, AND FLAME RETARDANT PROPERTIES

(76) Inventors: Rina Ai, Shanghai (CN); Sanjay Braj Mishra, Evansville, IN (US); Chris van der Weele, Sommelsdijk (NL); Nina P. Vaze, Stabroek (BE)

Correspondence Address: SABIC - O8CV - CPP;SABIC Innovative Plastics - IP Legal, ONE PLASTICS AVENUE, PITTSFIELD, MA, 01201-3697, US

(21) Appl. No.: 11/613,411

(22) Filed: Dec. 20, 2006

Related U.S. Application Data
(60) Provisional application No. 60/803,925, filed on Jun. 5, 2006.

(51) Int. Cl. C08G 73/10; C08K 5/02

(52) U.S. Cl. 524/104; 524/412; 524/464

(57) ABSTRACT

The invention relates to a molding composition containing: (a) a polycarbonate component; (b) a polyester component; (c) a polyamide component; (c) a halogenated flame retarding component; and (d) a carboxy reactive component. The composition exhibits excellent properties that are highly useful in applications such as electronic components. The composition may also contain other components, such as impact modifiers. The invention also relates to articles made from the composition as well as methods of making and using the composition.

This application claims priority to U.S. Provisional Application No. 60/803,925, which was filed Jun. 5, 2006, incorporated herein in its entirety.

### BACKGROUND OF THE INVENTION

Manufacturers of electrical components such as relay housing controls, timer housing structures, connectors, controls and switches have an ongoing need for materials that exhibit properties that are suitable for the components' intended operating conditions. Electrical components that exhibit poor performance properties, for instance, can cause electrical fires, device malfunctions, resulting in property and physical injuries. It is imperative that electrical component manufacturers develop products that avoid such malfunctions.

Polycarbonate is a useful engineering plastic for parts requiring clarity, high toughness, and, in some cases, good heat resistance. Polycarbonates, however, also have some important deficiencies, notably poor chemical and stress crack resistance, poor resistance to sterilization by gamma radiation, and poor processability.

Blends of polyesters with polycarbonates provide thermoplastic compositions having improved properties over those based upon either of the single resins alone. Further, such blends are often more cost effective than polycarbonate alone. Many applications of engineering plastics require that these polymers have ignition resistant properties along with other properties such as tensile strength, long-term thermal stability, high heat deflection temperature and chemical resistance.

Despite the use of polycarbonate-polyester blends in electronic applications, regulatory and product developments have increased the demand for materials that exhibit specific combination of physical properties.

JP2000053860 discloses a composition that contains 100 pts.wt. polyamide resin, 0.1-50 pts.wt. polycarbonate resin, 0-50 pts.wt. polyethylene terephthalate and 0.1-30 pts.wt. red phosphorus having a conductivity of 0.1-1,000 μS/cm. The document indicates that the conductivity of the red phosphorus is the conductivity of the aqueous extract obtained by adding 5 g of red phosphorus to 100 ml of deionized water, extraction-treating the red phosphorus at 121° C. for 100 hr and diluting the filtrate left after the filtration of red phosphorus to 250 ml. The red phosphorus used is desirably one coated with a thermosetting resin, especially, a thermoplastic phenolic resin. It is desirable that the composition additionally contains 5-140 pts.wt. per 100 pts.wt. polyamide resin.

EP0079177 discloses polyamide compositions with a halogenated organic flame retardant. The compositions are blended with a polymer blend resin, which is at least partially incompatible with and has a lower melt viscosity than the polyamide, to improve the arc tracking resistance of the polyamide composition. The compositions include from 5 to about 30% of a halogen derivative flame retardant and from about 1 to 20% of a polymer blend resin. Generally, the composition contains from about 30 to 90% by weight polyamide.

Despite documents disclosing such teachings, there remains an unmet need for formulations that meet specific physical properties. More particularly, there is still an unmet need for compositions that exhibit a Glow Wire Ignition Temperature that is at least 775° C. and (ii) a Comparative Tracking Index that is at least 250 V. Also, there remains an unmet need to develop compositions that also impart a flame retardance rating of V0, as per UL 94.

For the foregoing reasons, there is a need to develop improved materials useful for making electrical components.

For the foregoing needs, there is a need to develop articles that exhibit improved properties.

### BRIEF DESCRIPTION OF THE INVENTION

The invention relates to a molding composition comprising:
(a) a polycarbonate component;
(b) a polyester component;
(c) a polyamide component;
(d) a halogenated flame retarding component; and
(e) at least one carboxy reactive component;

wherein the polycarbonate component, the polyester component, the polyamide component, the halogenated flame retarding component, and the carboxy reactive component are present in sufficient amounts to impart (i) a Glow Wire Ignition Temperature that is at least 775° C. and (ii) a Comparative Tracking Index that is at least 250 V to a member selected from the group consisting of the composition, an article molded from the composition, an article extruded from the composition, and combinations thereof.

In one embodiment, the invention relates to a composition of matter comprising an article derived from a composition comprising:
(a) a polycarbonate component;
(b) a polyester component;
(c) a polyamide component;
(d) a halogenated flame retarding component;
(e) at least one carboxy reactive component;
(f) at least one impact modifier

wherein the polycarbonate component, the polyester component, the polyamide component, the halogenated flame retarding component, and the carboxy reactive component, and the impact modifier are present in sufficient amounts to impart a Glow Wire Ignition Temperature that is at least 775° C., a flame retardance rating of V0, as per UL 94 and a Comparative Tracking Index that is at least 250 V to the article.

In another embodiment, the invention relates to a composition comprising:
(a) from 15 to 40 wt % of a polycarbonate component;
(b) from 20 to 40 wt % of a polyester component;
(c) from more than 5 to 30 wt % of a polyamide component;
(d) from 5 to 15 wt % of a halogenated flame retarding component;
(e) at least 0.1 wt. % of a carboxy reactive component
(f) from 0 to 7 wt % of a flame retarding synergist selected from the group
(g) consisting of antimony trioxide, Sb₂O₃, antimony pentoxide Sb₂O₅, sodium antimonate, and combinations thereof, wherein the sum of (a), (b), (c), (d), (e) and (f) is 100 wt %.

In another embodiment, the invention relates to a composition comprising:
(a) from 40 to 55 wt % of a polycarbonate component;
(a) from 20 to 40 wt % of polyethylene terephthalate;
(b) from 2 to 7 wt % of a polyamide component;
(c) from 5 to 15 wt % of a halogenated flame retarding component;
(d) from 1 to 3 wt. % of a carboxy reactive component
(e) from 3 to 7 wt % of a flame retarding synergist selected from the group consisting of antimony trioxide, Sb₂O₃, antimony pentoxide Sb₂O₅, sodium antimonate, and combinations thereof,
(f) an impact modifier selected from the group consisting of acrylic pellets.
(g) a mold release agent selected from the group consisting hydrocarbon mold-release agents, fatty acids, aliphatic alcohols, polyhydric alcohols, polyglycols, polyglycerols, butyl stearate, pentaerythritol tetrastearate, and combination thereof,
(h) from 1 to 5 wt % of an additive selected from the group consisting of talc, hindered phenol stabilizers, poly(tetrafluoroethylene):styrene-acrylonile, and combinations thereof,

wherein the sum of (a), (b), (c), (d), (e), (f), (g), (h), and (i) is 100 wt %; and

wherein the polycarbonate component, the polyester component, the polyamide component, and the halogenated flame retarding component, and the carboxy reactive component are present in sufficient amounts to impart (i) a Glow Wire Ignition Temperature that is at least 775° C. and (ii) a Comparative Tracking Index that is at least 250 V to a member selected from the group consisting of the composition, an article molded from the composition, an article extruded from the composition, and combinations thereof.

And in another embodiment, the invention relates to methods for making and using the molding composition.

These and other features, aspects, and advantages of the present invention will become better understood with reference to the following description and appended claims.

### DETAILED DESCRIPTION OF THE INVENTION

The invention is based on the discovery that by using specific combinations of (a) a polycarbonate component; (b) a polyester component; (c) a polyamide component; (d) a halogenated flame retarding component; and (e) carboxy reactive component, it is possible to obtain a molding composition having a desired combination of physical properties. The molding composition is useful in making molded products such as electrical components. Advantageously, the composition and articles made from the composition exhibit excellent performance properties.

Other than in the operating examples or where otherwise indicated, all numbers or expressions referring to quantities of ingredients, reaction conditions, and the like, used in the specification and claims are to be understood as modified in all instances by the term “about” various numerical ranges are disclosed in this patent application. Because these ranges are continuous, they include every value between the minimum and maximum values. Unless expressly indicated otherwise, the various numerical ranges specified in this application are approximations.

Glow Wire Ignition Temperature (GWIT)—in accordance with IEC 60695-2-13, is expressed as the temperature (in degrees C.), which is 25 C hotter than the maximum temperature of the tip of the glow-wire which does not cause ignition of the material during three subsequent tests.

Comparative Tracking Index (CTI)—is expressed as that voltage which causes tracking after 50 drops of 0.1 percent ammonium chloride solution have fallen on the material. The results of testing at the nominal 3 mm thickness are considered representative of the material's performance in any thickness.

The V0 rating is a well-known and accepted flammability performance standard for plastic materials, as well as UL 94 ratings. This standard is intended to provide an indication of a material's ability to extinguish a flame, once ignited. Several ratings can be applied based on the rate of burning, time to extinguish, ability to resist dripping, and whether or not drips are burning. Each material tested may receive several ratings based on color and/or thickness. When specifying a material for an application, the UL rating should be applicable for the thickness used in the wall section in the plastic part. The UL rating should always be reported with the thickness; just reporting the UL rating without mentioning thickness is insufficient. V-0 burning stops within 10 seconds on a vertical specimen; no burning drips and no burn to holding clamp allowed. Compositions of this invention can be expected to achieve a UL94 rating of V0 at a thickness that is suitably lower than 1.5 mm and typically at 0.8 mm.

The invention relates to a molding composition comprising:
(a) a polycarbonate component;
(b) a polyester component;
(c) a polyamide component;
(d) a halogenated flame retarding component; and
(e) at least one carboxy reactive component;

wherein the polycarbonate component, the polyester component, the polyamide component, and the halogenated flame retarding component, and the carboxy reactive component are present in sufficient amounts to impart (i) a Glow Wire Ignition Temperature that is at least 775° C. and (ii) a Comparative Tracking Index that is at least 250 V to a member selected from the group consisting of the composition, an article molded from the composition, an article extruded from the composition, and combinations thereof.

In one embodiment, the polycarbonate component, the polyester component, the polyamide component, the halogenated flame retarding component and the carboxy reactive component are present in sufficient amounts to impart a flame retardance rating of V0, as per UL 94, to a member selected from the group consisting of the composition, an article molded from the composition, an article extruded from the composition, and combinations thereof. The composition can impart a Glow Wire Ignition Temperature that is at least 775° C. to the member at a thickness selected from the group consisting of 1 mm, 2 mm, and combinations thereof and (ii) a Comparative Tracking Index that is at least 250 V at a thickness of 3 mm. The composition can also contain the polycarbonate component, the polyester component, the polyamide component, the halogenated flame retarding component and the carboxy reactive component are present in sufficient amounts to impart, to the member a flame retardance rating of V0 at a thickness of 0.83 mm, as per UL 94.

The polycarbonate component of the molding composition is described below. As used herein, the terms “polycarbonate” and “polycarbonate resin” mean compositions having repeating structural carbonate units of the formula (1):

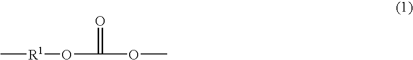

in which at least 60 percent of the total number of R¹ groups are aromatic organic radicals and the balance thereof are aliphatic, alicyclic, or aromatic radicals. In one embodiment, each R¹ is an aromatic organic radical, for example a radical of the formula (2):

-A¹-Y¹-A²- (2)

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical y¹ may be a hydrocarbon group or a saturated hydrocarbon group such as methylene, cyclohexylidene, or isopropylidene.

As used herein, the term “aliphatic” refers to a hydrocarbon radical having a valence of at least one including a linear or branched array of carbon atoms which is not cyclic; “aromatic” refers to a radical having a valence of at least one including at least one aromatic group; “cycloaliphatic” refers to a radical having a valence of at least one including an array of carbon atoms which is cyclic but not aromatic; “alkyl” refers to a straight or branched chain monovalent hydrocarbon radical; “alkylene” refers to a straight or branched chain divalent hydrocarbon radical; “alkylidene” refers to a straight or branched chain divalent hydrocarbon radical, with both valences on a single common carbon atom; “alkenyl” refers to a straight or branched chain monovalent hydrocarbon radical having at least two carbons joined by a carbon-carbon double bond; “cycloalkyl” refers to a non-aromatic alicyclic monovalent hydrocarbon radical having at least three carbon atoms, with at least one degree of unsaturation; “cycloalkylene” refers to a non-aromatic alicyclic divalent hydrocarbon radical having at least three carbon atoms, with at least one degree of unsaturation; “aryl” refers to a monovalent aromatic benzene ring radical, or to an optionally substituted benzene ring system radical system fused to at least one optionally substituted benzene rings; “arylene” refers to a benzene ring diradical or to a benzene ring system diradical fused to at least one optionally substituted benzene rings; “acyl” refers to a monovalent hydrocarbon radical joined to a carbonyl carbon atom, wherein the carbonyl carbon further connects to an adjoining group; “alkylaryl” refers to an alkyl group as defined above substituted onto an aryl as defined above; “arylalkyl” refers to an aryl group as defined above substituted onto an alkyl as defined above; “alkoxy” refers to an alkyl group as defined above connected through an oxygen radical to an adjoining group; “aryloxy” refers to an aryl group as defined above connected through an oxygen radical to an adjoining group; and “direct bond”, where part of a structural variable specification, refers to the direct joining of the substituents preceding and succeeding the variable taken as a “direct bond.”

Polycarbonates may be produced by the interfacial reaction of dihydroxy compounds having the formula HO—R¹—OH, which includes dihydroxy compounds of formula (3)

HO-A¹-Y¹-A²-OH (3)

wherein Y¹, A¹ and A² are as described above. Also included are bisphenol compounds of general formula (4):

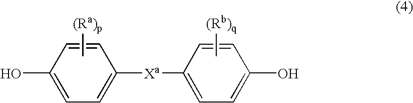

wherein R^{a} and R^{b} each represent a halogen atom or a monovalent hydrocarbon group and may be the same or different; p and q are each independently integers of 0 to 4; and X^{a} represents one of the groups of formula (5):

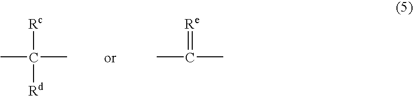

wherein R^{c} and R^{d} each independently represent a hydrogen atom or a monovalent linear or cyclic hydrocarbon group and Re is a divalent hydrocarbon group.

Some illustrative, non-limiting examples of suitable dihydroxy compounds include the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl) propane, bis(4-hydroxyphenyl)phenylmethane, 2,2-bis(4-hydroxy-3-bromo-phenyl)propane, 1,1-bis (hydroxyphenyl)cyclopentane, 1,1-bis(4-hydroxyphenyl)cyclohexane, 1,1-bis(4-hydroxy-3 methyl phenyl)cyclohexane 1,1-bis(4-hydroxyphenyl)isobutene, 1,1-bis(4-hydroxyphenyl)cyclododecane, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as combinations including at least one of the foregoing dihydroxy compounds.

Specific examples of the types of bisphenol compounds represented by formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl)phthalimidine (PPPBP), and 1,1-bis(4-hydroxy-3-methylphenyl)cyclohexane (DMBPC). Combinations including at least one of the foregoing dihydroxy compounds may also be used.

Branched polycarbonates are also useful, as well as blends of a linear polycarbonate and a branched polycarbonate. The branched polycarbonates may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents may be added at a level of 0.05 to 2.0 wt. % of the polycarbonate. All types of polycarbonate end groups are contemplated as being useful in the polycarbonate, provided that such end groups do not significantly affect desired properties of the thermoplastic compositions.

In a specific embodiment, the polycarbonate is a linear homopolymer derived from bisphenol A, in which each of A¹ and A² is p-phenylene and Y¹ is isopropylidene. The polycarbonates may have an intrinsic viscosity, as determined in chloroform at 25° C., of 0.3 to 1.5 deciliters per gram (dl/g), specifically 0.45 to 1.0 dl/g. The polycarbonates may have a weight average molecular weight (Mw) of 10,000 to 100,000, as measured by gel permeation chromatography (GPC) using a crosslinked styrene-divinyl benzene column, at a sample concentration of 1 milligram per milliliter, and as calibrated with polycarbonate standards.

“Polycarbonates” and “polycarbonate resin” as used herein may include copolymers including carbonate chain units. A specific suitable copolymer is a polyester-polycarbonate, also known as a copolyester-polycarbonate and polyestercarbonate. Combinations of polycarbonates and polyester-polycarbonates may also be used. As used herein, a “combination” is inclusive of all mixtures, blends, alloys, reaction products, and the like. Polyester-polycarbonates contain, in addition to recurring carbonate chain units of the formula (1), repeating units of formula (6):

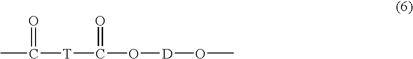

wherein D is a divalent radical derived from a dihydroxy compound, and may be, for example, a C₂₋₁₀ alkylene radical, a C₆₋₂₀ alicyclic radical, a C₆₋₂₀ aromatic radical or a polyoxyalkylene radical in which the alkylene groups contain 2 to 6 carbon atoms, specifically 2,3, or 4 carbon atoms; and T divalent radical derived from a dicarboxylic acid, and may be, for example, a C₂₋₁₀ alkylene radical, a C₆₋₂₀ alicyclic radical, a C₆₋₂₀ alkyl aromatic radical, or a C₆₋₂₀ aromatic radical.

In one embodiment, D is a C₂₋₆ alkylene radical. In another embodiment, D is derived from an aromatic dihydroxy compound of formula (7):

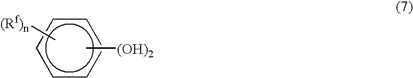

wherein each R^{f} is independently a halogen atom, a C₁₋₁₀ hydrocarbon group, or a C₁₋₁₀ halogen substituted hydrocarbon group, and n is 0 to 4. The halogen is usually bromine. Examples of compounds that may be represented by the formula (7) include resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like; or combinations including at least one of the foregoing compounds.

Specifically, the polyester unit of a polyester-polycarbonate can be derived from the reaction of a combination of isophthalic and terephthalic diacids (or derivatives thereof) with resorcinol, bisphenol A, or a combination including one or more of these, wherein the molar ratio of isophthalate units to terephthalate units is 91:9 to 2:98, specifically 85:15 to 3:97, more specifically 80:20 to 5:95, and still more specifically 70:30 to 10:90. The polycarbonate units can be derived from resorcinol and/or bisphenol A, in a molar ratio of resorcinol carbonate units to bisphenol A carbonate units of 0:100 to 99:1, and the molar ratio of the mixed isophthalate-terephthalate polyester units to the polycarbonate units in the polyester-polycarbonate can be 1:99 to 99:1, specifically 5:95 to 90:10, more specifically 10:90 to 80:20. Where a blend of polyester-polycarbonate with polycarbonate is used, the weight ratio of polycarbonate to polyester-polycarbonate in the blend can be, respectively, 1:99 to 99:1, specifically 10:90 to 90:10.

The polyester-polycarbonates may have a weight-averaged molecular weight (Mw) of 1,500 to 100,000, specifically 1,700 to 50,000, and more specifically 2,000 to 40,000. Molecular weight determinations are performed using gel permeation chromatography (GPC), using a crosslinked styrene-divinylbenzene column and calibrated to polycarbonate references. Samples are prepared at a concentration of about 1 mg/ml, and are eluted at a flow rate of about 1.0 ml/min.

Suitable polycarbonates can be manufactured by processes such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., 8 to 10. The most commonly used water immiscible solvents include methylene chloride, 1,2-dichloroethane, chlorobenzene, toluene, and the like. Suitable carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations containing at least one of the foregoing types of carbonate precursors may also be used. A chain stopper (also referred to as a capping agent) may be included during polymerization. The chain-stopper limits molecular weight growth rate, and so controls molecular weight in the polycarbonate. A chain-stopper may be at least one of mono-phenolic compounds, mono-carboxylic acid chlorides, and/or mono-chloroformates.

For example, mono-phenolic compounds suitable as chain stoppers include monocyclic phenols, such as phenol, C₁-C₂₂ alkyl-substituted phenols, p-cumyl-phenol, p-tertiary-butyl phenol, hydroxy diphenyl; monoethers of diphenols, such as p-methoxyphenol. Alkyl-substituted phenols include those with branched chain alkyl substituents having 8 to 9 carbon atoms. A mono-phenolic UV absorber may be used as capping agent. Such compounds include 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like. Specifically, mono-phenolic chain-stoppers include phenol, p-cumylphenol, and/or resorcinol monobenzoate.

Mono-carboxylic acid chlorides may also be suitable as chain stoppers. These include monocyclic, mono-carboxylic acid chlorides such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and mixtures thereof; polycyclic, mono-carboxylic acid chlorides such as trimellitic anhydride chloride, and naphthoyl chloride; and mixtures of monocyclic and polycyclic mono-carboxylic acid chlorides. Chlorides of aliphatic monocarboxylic acids with up to 22 carbon atoms are suitable. Functionalized chlorides of aliphatic monocarboxylic acids, such as acryloyl chloride and methacryoyl chloride, are also suitable. Also suitable are mono-chloroformates including monocyclic, mono-chloroformates, such as phenyl chloroformate, alkyl-substituted phenyl chloroformate, p-cumyl phenyl chloroformate, toluene chloroformate, and mixtures thereof.

The amount of the polycarbonate component varies with the specific application. Generally, the amount of the polycarbonate component varies with the specific application. Generally, The amount of the polycarbonate component varies with the specific application. Generally, the amount of the polycarbonate component is present in an amount that is at least 15 wt. %. In one embodiment, the polycarbonate component is present in an amount ranging from 15 to 40 wt %. In another embodiment, the amount of polycarbonate present in the composition ranges from 15 to 45 wt. %. In another embodiment, the polycarbonate component is present in an amount ranging from 15 wt % to 50 wt %. In another embodiment, the polycarbonate component is present in an amount ranging from 40 wt % to 55 wt %.

Suitable polyesters include those including structural units of the following formula:

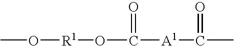

wherein each R¹ is independently a divalent aliphatic, alicyclic or aromatic hydrocarbon or polyoxyalkylene radical, or mixtures thereof and each A¹ is independently a divalent aliphatic, alicyclic or aromatic radical, or mixtures thereof. Examples of suitable polyesters containing the structure of the above formula are poly(alkylene dicarboxylates), liquid crystalline polyesters, and polyester copolymers. It is also possible to use a branched polyester in which a branching agent, for example, a glycol having three or more hydroxyl groups or a trifunctional or multifunctional carboxylic acid has been incorporated. Furthermore, it is sometimes desirable to have various concentrations of acid and hydroxyl end groups on the polyester, depending on the ultimate end-use of the composition.

The R¹ radical may be, for example, a C₂₋₁₀ alkylene radical, a C₆₋₁₂ alicyclic radical, a C₆₋₂₀ aromatic radical or a polyoxyalkylene radical in which the alkylene groups contain about 2-6 and most often 2 or 4 carbon atoms. The A¹ radical in the above formula is most often p- or m-phenylene, a cycloaliphatic or a mixture thereof. This class of polyester includes the poly(alkylene terephthalates). Such polyesters are known in the art as illustrated by the following patents, which are incorporated herein by reference. U.S. Pat. Nos. 2,465,319; 2,720,502; 2,727,881; 2,822,348; 3,047,539; 3,671,487; 3,953,394 and 4,128,526.

Examples of aromatic dicarboxylic acids represented by the dicarboxylated residue A¹ are isophthalic or terephthalic acid, 1,2-di(p-carboxyphenyl)ethane, 4,4′-dicarboxydiphenyl ether, 4,4′ bisbenzoic acid and mixtures thereof. Acids containing fused rings can also be present, such as in 1,4-1,5- or 2,6-naphthalenedicarboxylic acids. The preferred dicarboxylic acids are terephthalic acid, isophthalic acid, naphthalene dicarboxylic acid, cyclohexane dicarboxylic acid or mixtures thereof. Particularly suitable polyesters are poly(ethylene terephthalate) (“PET”), and poly(1,4-butylene terephthalate), (“PBT”), poly(butylene naphthanoate), (“PBN”), poly(cyclohexanedimethylene terephthalate) (“PCT”), cyclohexanedimethanol modified poly(ethylene terephthalate also known as polycyclohexylenedimethylene ethylene terephthalate) (“PETG” and “PCTG”), and (polypropylene terephthalate) (“PPT”), and mixtures thereof.

Also contemplated herein are the above polyesters with minor amounts, e.g., from 0.5 to about 25 percent by weight, of units derived from aliphatic acid and/or aliphatic polyols to form copolyesters. The aliphatic polyols include glycols, such as polytetramethylene glycol or poly(ethylene glycol) or poly(butylene glycol). Such polyesters can be made by known processes, e.g., those taught by the teachings in U.S. Pat. Nos. 2,465,319 and 3,047,539.

The amount of the polyester component can vary, depending on the application. In one embodiment, the polyester component is present in an amount that is at least 20 wt. %. In another embodiment, the polyester component is present in an amount ranging from 20 to 40 wt %.

The polyamide component generally includes at least one polyamide, such that when it is used in accordance to the invention, the resulting composition imparts useful properties.

Suitable polyamide resins are a generic family of resins known as Nylons, characterized by the presence of an amide group (—C(O)NH—). Nylon-6 and Nylon-6,6 are the generally preferred polyamides and are available from a variety of commercial sources. Other polyamides, however, such as Nylon-4,6, Nylon-12, Nylon-6,10, Nylon-6,9, Nylon-6/6T and Nylon-6,6/6T with triamine contents below 0.5 weight percent, as well as others, such as the amorphous Nylons may be useful for particular poly(arylene ether)-polyamide applications. Mixtures of various polyamides, as well as various polyamide copolymers, are also useful. A highly preferred polyamide is Nylon-6, 6.

The polyamides can be obtained by a number of well known processes such as those described in U.S. Pat. Nos. 2,071,250; 2,071,251; 2,130,523; 2,130,948; 2,241,322; 2,312,966; and 2,512,606. Nylon-6, for example, is a polymerization product of caprolactam. Nylon-6,6 is a condensation product of adipic acid and 1,6-diaminohexane. Likewise, Nylon-4,6 is a condensation product of adipic acid and 1,4-diaminobutane. Besides adipic acid, other useful diacids for the preparation of Nylons include azelaic acid, sebacic acid, dodecane diacid, as well as terephthalic and isophthalic acids, and the like. Other useful diamines include m-xylyene diamine, di-(4-aminophenyl)methane, di-(4-aminocyclohexyl)methane, 2,2-di-(4-aminophenyl)propane, 2,2-di-(4-aminocyclohexyl)propane, among others. Copolymers of caprolactam with diacids and diamines are also useful.

Specific examples of polyamides include those selected from polycaproamide, polyhexamethylene adipamide, polyhexathylene sebacamide, polyundecamethylene adipamide, polyundecanamide, polydodecanamide copolymerized polyamides of the foregoing, and combinations thereof. A suitable selection of polaymides can be selected from the group consisting of Nylon-6 and Nylon-6,6 Nylon-4,6, Nylon-12, Nylon-6,10, Nylon-6,9, Nylon-6/6T, Nylon-6,6/6T, polycaproamide, polyhexamethylene adipamide, polyhexathylene sebacamide, polyundecamethylene adipamide, polyundecanamide, polydodecanamide copolymerized polyamides of the foregoing, and combinations thereof.

The amount of the polyamide component is generally more than 5 wt %. In one embodiment, the amount of the polyamide component is at least 10 wt %. In one embodiment, the amount of the polyamide component ranges from 5 to 30 wt %, or 10 to 30 wt %. In another embodiment, the amount of the polyamide component ranges from 20 to 25 wt. %.

The halogenated fire retarding component can include any halogenated fire retarding agent, which when used in accordance with the invention, produces a molding composition that exhibits useful properties. Examples of suitable halogenated fire retarding agents include and are not limited to ethane-1,2-bis[pentabromophenyl, brominated polystyrene, poly(pentabromobenzylacrylate), 1,2-bis-(tetrabromophthalimido)ethane, phenol-capped carbonate pentamers of tetrabromobisphenol-A-carbonate oligomers (TBBPA), 2,4,6-tribromophenol capped tetrabromobisphenolA-carbonate oligomers, brominated polycarbonates, tetrabromo bisphenol a diglycidyl ether & brominated. The halogenated fire retarding components are made by known methods and are commercially available from various vendors.

The amount of the halogenated fire retarding component can vary, depending on application. Generally, the flame retarding component is present in an amount that is at least 5 wt %. In one embodiment, the amount of the halogenated fire retarding component ranges from 5 to 15 wt %, or from 5 to 30 wt %, or more. In another embodiment, the amount of the halogenated fire retarding component ranges from 6 to 8 wt %. The halogen content can vary, depending on composition and needs. In one embodiment, for instance, the bromine content is can be at least about 5 wt %, based on the weight of the halogenated fire retarding compositions.

The halogenated fire retarding component can be used in conjunction with flame retarding synergists. Suitable synergists can be selected from the group of antimony trioxide, Sb₂O₃, antimony pentoxide Sb₂O₅, sodium antimonate, and combinations thereof. Such synergists can be used in amounts that are at least 2 or 3 wt %. Specific ranges can be from 2 to 7 wt %, or more, or 3 to 7 wt %, or more.

The carboxy reactive component is generally added to improve the homogeneity of blends and is a polyfunctional carboxy reactive material that can be either polymeric or non-polymeric. Accordingly, the carboxy reactive component can be selected from the group consisting of polymeric polyfunctional carboxy reactive materials, non-polymeric carboxy reactive materials, and combinations thereof. Examples of carboxy reactive groups include and are not limited to epoxides, carbodiimides, orthoesters, oxazolines, oxiranes, aziridines, anhydrides, reactive silicone containing materials of the foregoing, and combinations thereof.

The carboxy reactive material can also include other functionalities that are either reactive or non-reactive under the described processing conditions. Non-limiting examples of reactive moieties include reactive silicone containing materials, for example epoxy modified silicone monomers and polymeric materials. If desired, a catalyst or co-catalyst system can be used to accelerate the reaction between the polyfunctional carboxy-reactive material and other components of the composition. The term “poly” means at least two functional groups that can react with a carboxy group.

Particularly useful polyfunctional carboxy reactive materials include materials with more than one reactive epoxy group. The polyfunctional epoxy compound may contain aromatic and/or aliphatic residues. Typical examples used in the art include 3,4-epoxycyclohexylmethyl-3,4-epoxycyclohexanecarboxylate, epoxy phenol NOVOLAC™ ™ resins, epoxy cresol NOVOLAC™ resins, epoxidized vegetable (soybean, linseed) oils, styrene-acrylic copolymers containing pendant glycidyl groups and glycidyl methacrylate containing oligomers, polymers and copolymers.

Preferred materials with multiple epoxy groups are styrene-acrylic copolymers and oligomers containing glycidyl groups incorporated as side chains. Several useful examples are described in the International Patent Application WO 03/066704 A1 assigned to Johnson Polymer, LLC, incorporated herewith. These materials are based on oligomers with styrene and acrylate building blocks that have desirable glycidyl groups incorporated as side chains. A high number of epoxy groups per oligomer chain is desired, at least about 10, preferably greater than about 15, and more preferably greater than about 20. These polymeric materials generally have a molecular weight greater than about 3000, preferably greater than about 4000, and more preferably greater than about 6000. These are commercially available from Johnson Polymer, LLC under the Joncryl™. trade name, preferably Joncryl™ ADR 4368 material. It is also commonly referred to as CESA ADR 4368. Other preferred materials with multiple epoxy groups are other acrylic or polyolefin copolymers and oligomers containing glycidyl groups incorporated as side chains.

Epoxy functionalized materials are available from Dow Chemical Company under the trade name DER-332, from Resolution Performance Products under the trade name EPON Resin 1001F, 1004F, 1005F, 1007F, and 1009F; from Shell Oil Corporation under the trade names Epon 826, 828, and 871; from Ciba-Giegy Corporation under the trade names CY-182 and CY-183; and from DOW under the trade name ERL-4221 and ERL-4299.

In one embodiment, the carboxy reactive component can have impact modifying properties. An example of such a carboxy reactive material is a co- or ter-polymer including units of ethylene and glycidyl methacrylate (GMA), sold by Arkema. Typical composition of such glycidyl ester impact modifier is about 67 wt % ethylene, 25 wt % methyl methacrylate and 8 wt % glycidyl methacrylate impact modifier, available from Atofina under the brand name LOTADER 8900). Another example of a carboxy reactive component that has impact modifying properties is a terpolymer made of ethylene, butyl acrylate and glycidyl methacrylate (e.g., the ELVALOY PT or PTW series from Dupont).

The amount of the carboxy reactive component is generally at least 0.01 wt. %. In one embodiment, the amount of the polyfunctional carboxy reactive component ranges from 0.01 to 10 wt %, depending on the specific compound. In one embodiment, the amount of the carboxy reactive component ranges from 0.1 to 0.3 wt %.

The composition can further comprise at least one impact modifier. Such impact modifiers are not carboxy reactive. The impact modifiers generally is a material, which when used in accordance with the invention, improves the impact properties of the composition. Useful impact modifiers are substantially amorphous copolymer resins, including but not limited to acrylic rubbers, ASA rubbers, diene rubbers, organosiloxane rubbers, EPDM rubbers, SBS or SEBS rubbers, ABS rubbers, MBS rubbers and glycidyl ester impact modifiers. The acrylic rubber is preferably core-shell polymers built up from a rubber-like core on which one or more shells have been grafted. Typical core material consists substantially of an acrylate rubber. Preferable the core is an acrylate rubber of derived from a C4 to C12 acrylate. Typically, one or more shells are grafted on the core. Usually these shells are built up for the greater part from a vinyl aromatic compound and/or a vinyl cyanide and/or an alkyl(meth)acrylate and/or (meth)acrylic acid. Preferable the shell is derived from an alkyl(meth)acrylate, more preferable a methyl(meth)acrylate. The core and/or the shell(s) often comprise multi-functional compounds that may act as a cross-linking agent and/or as a grafting agent. These polymers are usually prepared in several stages. The preparation of core-shell polymers and their use as impact modifiers are described in U.S. Pat. Nos. 3,864,428 and 4,264,487. Especially preferred grafted polymers are the core-shell polymers available from Rohm & Haas under the trade name PARALOID®, including, for example, PARALOID® EXL3691 and PARALOID® EXL3330, EXL3300 and EXL2300. Core shell acrylic rubbers can be of various particle sizes. The preferred range is from 300-800 nm, however larger particles, or mixtures of small and large particles, may also be used. In some instances, especially where good appearance is required acrylic rubber with a particle size of 350-450 nm may be preferred. In other applications where higher impact is desired acrylic rubber particle sizes of 450-550 nm or 650-750 nm may be employed. Acrylic impact modifiers contribute to heat stability and UV resistance as well as impact strength of polymer compositions. Other preferred rubbers useful herein as impact modifiers include graft and/or core shell structures having a rubbery component with a Tg (glass transition temperature) below 0° C., preferably between about −40° to about −80° C., which comprise poly-alkylacrylates or polyolefins grafted with poly(methyl)methacrylate or styrene-acrylonitrile copolymer. Preferably the rubber content is at least about 10% by weight, most preferably, at least about 50%.

Typical other rubbers for use as impact modifiers herein are the butadiene core-shell polymers of the type available from Rohm & Haas under the trade name PARALOID® EXL2600. Most preferably, the impact modifier will comprise a two stage polymer having a butadiene based rubbery core, and a second stage polymerized from methylmethacrylate alone or in combination with styrene. Impact modifiers of the type also include those that comprise acrylonitrile and styrene grafted onto cross-linked butadiene polymer, which are disclosed in U.S. Pat. No. 4,292,233 herein incorporated by reference.

Other suitable impact modifiers may be mixtures comprising core shell impact modifiers made via emulsion polymerization using alkyl acrylate, styrene and butadiene. These include, for example, methylmethacrylate-butadiene-styrene (MBS) and methylmethacrylate-butylacrylate core shell rubbers.

Among the other suitable impact modifiers are the so-called block copolymers and rubbery impact modifiers, for example, A-B-A triblock copolymers and A-B diblock copolymers. The A-B and A-B-A type block copolymer rubber additives which may be used as impact modifiers include thermoplastic rubbers comprised of one or two alkenyl aromatic blocks which are typically styrene blocks and a rubber block, e.g., a butadiene block which may be partially hydrogenated. Mixtures of these triblock copolymers and diblock copolymers are especially useful.

Suitable A-B and A-B-A type block copolymers are disclosed in, for example, U.S. Pat. Nos. 3,078,254, 3,402,159, 3,297,793, 3,265,765, and 3,594,452 and U.K. Patent 1,264,741. Examples of typical species of A-B and A-B-A block copolymers include polystyrene-polybutadiene (SB), polystyrene-poly(ethylene-propylene), polystyrene-polyisoprene, poly(α-methylstyrene)-polybutadiene, polystyrene-polybutadiene-polystyrene (SBS), polystyrene-poly(ethylene-propylene)-polystyrene, polystyrene- polyisoprene-polystyrene and poly(α-methylstyrene)-polybutadiene-poly(α-methylstyrene), as well as the selectively hydrogenated versions thereof, and the like. Mixtures comprising at least one of the aforementioned block copolymers are also useful. Such A-B and A-B-A block copolymers are available commercially from a number of sources, including Phillips Petroleum under the trademark SOLPRENE, Shell Chemical Co., under the trademark KRATON, Dexco under the trade name VECTOR, and Kuraray under the trademark SEPTON.

The impact modifier can also include a vinyl aromatic-vinyl cyanide copolymer. Suitable vinyl cyanide compounds include acrylonitrile and substituted vinyl cyanides such a methacrylonitrile. Preferably the impact modifier comprises styrene-acrylonitrile copolymer (hereinafter SAN). The preferred SAN composition comprises at least 10, preferably 25 to 28, percent by weight acrylonitrile (AN) with the remainder styrene, para-methyl styrene, or alpha methyl styrene. Another example of SANs useful herein include those modified by grafting SAN to a rubbery substrate such as, for example, 1,4-polybutadiene, to produce a rubber graft polymeric impact modifier. High rubber content (greater than 50% by weight) resin of this type (HRG-ABS) may be especially useful for impact modification of polyester resins and their polycarbonate blends.

Another class of preferred impact modifiers, referred to as high rubber graft ABS modifiers, comprise greater than or equal to about 90% by weight SAN grafted onto polybutadiene, the remainder being free SAN. ABS can have butadiene contents between 12% and 85% by weight and styrene to acrylonitrile ratios between 90:10 and 60:40. Preferred compositions include: about 8% acrylonitrile, 43% butadiene and 49% styrene, and about 7% acrylonitrile, 50% butadiene and 43% styrene, by weight. These materials are commercially available under the trade names BLENDEX 336 and BLENDEX 415 respectively (Crompton Co.).

Improved impact strength is obtained by melt compounding polybutylene terephthalate with ethylene homo- and copolymers functionalized with either acid or ester moieties as taught in U.S. Pat. Nos. 3,405,198; 3,769,260; 4,327,764; and 4,364,280. Polyblends of polybutylene terephthalate with a styrene-alpha-olefin-styrene triblock are taught in U.S. Pat. No. 4,119,607. U.S. Pat. No. 4,172,859 teaches impact modification of polybutylene terephthalate with random ethylene-acrylate copolymers and EPDM rubbers grafted with a monomeric ester or acid functionality.

Preferred impact modifiers include core-shell impact modifiers, such as those having a core of poly(butyl acrylate) and a shell of poly(methyl methacrylate).

When an impact modifier is used, the amount of the impact modifier is generally at least 2 wt. %. A combination of impact modifiers can also be used. In one embodiment, the total amount of impact modifiers used ranges from 2 wt % to 10 wt % and more preferably from 2 wt % to 7 wt.

The composition can also contain other additives. In one embodiment, the molding composition can further include mold-release agents. Examples of the mold-release agents include, but are not limited to natural and synthetic paraffins, polyethylene waxes, fluorocarbons, and other hydrocarbon mold-release agents; stearic acid, hydroxystearic acid, and other higher fatty acids, hydroxyfatty acids, and other fatty acid mold-release agents; stearic acid amide, ethylenebisstearamide, and other fatty acid amides, alkylenebisfatty acid amides, and other fatty acid amide mold-release agents; stearyl alcohol, cetyl alcohol, and other aliphatic alcohols, polyhydric alcohols, polyglycols, polyglycerols and other alcoholic mold release agents; butyl stearate, pentaerythritol tetrastearate, and other lower alcohol esters of fatty acid, polyhydric alcohol esters of fatty acid, polyglycol esters of fatty acid, and other fatty acid ester mold release agents; silicone oil and other silicone mold release agents, and mixtures of any of the aforementioned. The mold release agent can be used in conjunction with other additives, e.g., TEFLON styrene acrylonitrile

The amount of the mold release agent can be in the molding composition is generally at least 0.1 wt. %. In one embodiment, the amount of the mold release agent ranges from 0.1 to 2 wt. %. In another embodiment, the amount of the mold release agent ranges from 0.5 to 1 wt. %.

A molding composition of the invention may further contain a heat stabilizer. Suitable heat stabilizers include, but are not limited to, hindered phenol stabilizers, organic thioether stabilizers, organic phosphite stabilizers, hindered amine stabilizers, epoxy stabilizers and mixtures thereof. The heat-resistant stabilizer may be added in the form of a solid or liquid.

The amount of the heat stabilizer that can be in the molding composition is generally at least 0.01 wt. %. In one embodiment, the amount of the heat stabilizer ranges from 0.01 to 0.5 wt. %. In another embodiment, the amount of the heat stabilizer ranges from 0.05 to 1 wt. %. In another embodiment, the amount of the heat stabilizer ranges from 0.05 to 3 wt. %.

Other additives include and are not limited to mono zinc phosphate, antioxidants, Sb₂O₃—PBT masterbatch materials, low density polyethylene, potassium diphenylsulphone sulfonate, Ultratalc, pentaerythritol tetrastearate, and Teflon powder. The amount of such additional additives can vary. Generally, the amount is at least 0.01 wt. %. In one embodiment, the amount of the heat stabilizer ranges from 0.01 to 0.5 wt. %. In another embodiment, the amount of the heat stabilizer ranges from 0.05 to 1 wt. %. In another embodiment, the amount of the heat stabilizer ranges from 0.05 to 3 wt. %.

A molding composition of the invention is generally made by combining suitable amounts of the a polycarbonate component; the polyester component, the polyamide component; the halogenated flame retarding component; and the carboxy reactive component, in an extruder (or a functionally equivalent compounding device) under suitable conditions. The polycarbonate component; the polyester component, the polyamide component; the halogenated flame retarding component; the impact modifier and the carboxy reactive component (and any additional components) may be compounded simultaneously, separately, or in combinations containing two or three of the components. The extrusion process can include one or more passes through an extruder.

An article is generally made typically by injection molding using the following procedure. Injection molding is a process wherein an amount of polymer several times that necessary to produce an article is heated in a heating chamber to a viscous liquid and then injected under pressure into a mold cavity. The polymer remains in the mold cavity under high pressure until it is cooled and is then removed. The term “injection molding” also encompasses the relatively new advance of reaction injection molding, wherein a two part semi-liquid resin blend is made to flow through a nozzle and into a mold cavity where it polymerizes as a result of a chemical reaction. Injection molding and injection molding apparatii are discussed in further detail in U.S. Pat. Nos. 3,915,608 to Hujick; 3,302,243 to Ludwig; and 3,224,043 to Lameris. Injection molding is the fastest of the thermoplastic processes, and thus is generally used for large volume applications such as automotive and consumer goods. The cycle times range between 20 and 60 seconds. Injection molding also produces highly repeatable near-net shaped parts. The ability to mold around inserts, holes and core material is another advantage. Finally, injection molding generally offer the best surface finish of any process. The skilled artisan will know whether injection molding is the best particular processing method to produce a given article according to the present invention. In one embodiment, pellets of the composition are dried in an oven over a suitable period, e.g., 12 hrs. at 120° C., molded in injection molding machine with a suitable melt temperature profile, e.g., 100-240-250-260-260° C., where the temperature of the mold is kept suitably for processing, e.g., at 60° C.

Accordingly, the invention provides articles with many useful properties. In one embodiment, the invention relates to an article comprising:
(a) a polycarbonate component;
(b) a polyester component;
(c) a polyamide component;
(d) a halogenated flame retarding component;
(e) at least one carboxy reactive component;
(f) at least one impact modifier

wherein the polycarbonate component, the polyester component, the polyamide component, the halogenated flame retarding component, and the carboxy reactive component, and the impact modifier are present in sufficient amounts to impart a Glow Wire Ignition Temperature that is at least 775° C., a flame retardance rating of V0, as per UL 94 and a Comparative Tracking Index that is at least 250 V to the article.

In another embodiment, the invention relates to a molding composition containing:
(a) from 15 to 40 wt % of a polycarbonate component;
(b) from 20 to 40 wt % of a polyester component;
(c) from more than 5 to 30 wt % of a polyamide component;
(d) from 5 to 15 wt % of a halogenated flame retarding component;
(e) at least 0.1 wt. % of a carboxy reactive component
(f) from 0 to 7 wt % of a flame retarding synergist selected from the group consisting of antimony trioxide, Sb₂O₃, antimony pentoxide Sb₂O₅, sodium antimonate, and combinations thereof; wherein the sum of (a), (b), (c), (d), (e) and (f) is 100 wt %.

It will be appreciated, however, that embodiments of our invention can include other compositions. For instance, the composition can include:
(a) from 40 to 55 wt % of a polycarbonate component;
(b) from 20 to 40 wt % of polyethylene terephthalate;
(c) from 2 to 7 wt % of a polyamide component;
(d) from 5 to 15 wt % of a halogenated flame retarding component;
(e) from 1 to 3 wt. % of a carboxy reactive component
(f) from 3 to 7 wt % of a flame retarding synergist selected from the group consisting of antimony trioxide, Sb₂O₃, antimony pentoxide Sb₂O₅, sodium antimonate, and combinations thereof,
(g) an impact modifier selected from the group consisting of acrylic pellets
(h) a mold release agent selected from the group consisting hydrocarbon mold-release agents, fatty acids, aliphatic alcohols, polyhydric alcohols, polyglycols, polyglycerols, butyl stearate, pentaerythritol tetrastearate, and combination thereof;
(i) from 1 to 5 wt % of an additive selected from the group consisting of talc, hindered phenol stabilizers, poly(tetrafluoroethylene):styrene-acrylonile, and combinations thereof; such that the sum of (a), (b), (c), (d), (e), (f), (g), (h), and (i) is 100 wt %. The halogenated flame retarding agent can be halogenated flame retarding agent is brominated polystyrene and wherein the sum of (a), (b), (c), (d), (e), (f), (g), (h), and (i) is 100 wt %; and wherein the polycarbonate component, the polyester component, the polyamide component, and the halogenated flame retarding component, and the carboxy reactive component are present in sufficient amounts to impart (i) a Glow Wire Ignition Temperature that is at least 775° C. and (ii) a Comparative Tracking Index that is at least 250 V to a member selected from the group consisting of the composition, an article molded from the composition, an article extruded from the composition, and combinations thereof. Such a composition can also include components in the amounts indicated their respective descriptions.

Advantageously, our composition does not require materials that are found in conventional compositions. For instance, our composition can be effective without the presence of red phosphorous. In one embodiment, our composition contains less than 5 wt % of red phosphorous. In another embodiment, our composition contains less than 3 or 2, or 1 wt % of red phosphorous. In another embodiment, our composition does not contain any red phosphorous.

Our compositions can be used to make compositions of matter comprising articles. Examples of suitable articles include and are not limited to relay housing controls, timer housing structures, connectors, controls and switches. In one embodiment, for instance, a suitable article may include an electric connector which includes a connector shell and a conductor rack, the conductor rack including a-shaped rack body having a top wall, a bottom wall, and a side wall connected between a rear end of the top wall and a rear end of the bottom wall at one end, the bottom wall having a plurality of wire holes at a front end thereof, and a plurality of conductors respectively inserted through the wire holes on the bottom wall and extended out of the rack body. It will be appreciated that such articles can be derived from compositions described herein.

The invention includes embodiments in which compositions used to make such above-mentioned articles contain polycarbonate in an amount ranging from 15 to 45 wt %, the polyester component is present in an amount ranging from 20 to 40 wt %, the polyamide component is present in an amount ranging in an amount ranging from 10 to 30 wt %, the halogenated flame retarding component is present in an amount ranging from 5 to 15 wt. %, and the carboxy reactive is present in an amount ranging from 1 to 10 wt % and the impact modifier is present in an amount ranging from 1 to 10%; wherein the sum of the wt % of the polycarbonate, the polyester component, the polyamide component, the halogenated flame retarding component, the carboxy reactive component, and the impact modifier is 100 wt %. In another embodiment, the polycarbonate component is present in an amount ranging from 15 to 45 wt %, the polyester component is present in an amount ranging from 20 to 40 wt %, the polyamide component is present in an amount ranging in an amount ranging from 10 to 30 wt %, the halogenated flame retarding component is present in an amount ranging from 5 to 15 wt. %, the carboxy reactive component is present in an amount ranging from 1 to 10 wt %; wherein the sum of the polycarbonate, the polyester component, the polyamide component, the halogenated flame retarding component, the carboxy reactive component, and the impact modifier is 100 wt %.

The physical properties of the compositions and the articles made, e.g. (articles molded or extruded from the compositions) from the compositions generally exhibit highly useful combination of GWIT, CTI and flame retarding properties. Generally, the polycarbonate component, the polyester component, the polyamide component, the halogenated flame retarding component, and the carboxy reactive component are present in sufficient amounts to impart (i) a GWIT that is at least 775° C. and (ii) a CTI that is at least 250 V to the composition or to an article molded or extruded from the composition. Particularly suitable compositions (and articles molded or extruded from the compositions) also exhibit a flame retardance rating of V0, as per UL 94. Our compositions can impart GWIT, CTI, and V0 properties at various thicknesses. For instance, the composition can impart a Glow Wire Ignition Temperature that is at least 775° C. at a thickness selected from the group consisting of 1 mm, 2 mm, and combinations thereof and (ii) a Comparative Tracking Index that is at least 250 V at a thickness of 3 mm and (iii) a flame retardance rating of V0 at a thickness of 0.83 mm, as per UL 94 to a member selected from the group consisting of the composition, an article molded from the composition, an article extruded from the composition, and combinations thereof.

The invention is further described in the following illustrative examples in which all parts and percentages are by weight unless otherwise indicated.

### EXAMPLES

### Examples 1-19 and Comparative Examples 1-4

### Standards/Procedures

Glow Wire Ignition Temperature (GWIT)—in accordance with IEC 695-2-1/3, was expressed as the temperature (in degrees C.), which is 25 C hotter than the maximum temperature of the tip of the glow-wire which does not cause ignition of the material during three sequential tests. Since the target requirement of GWIT for the inventive compositions was 775 deg C. at 2 mm thickness, a pass/fail criterion was employed. If the GWIT value exceeded 775 deg C., the respective composition was deemed to have passed the test. If GWIT was less than 775 deg C., it was deemed to have failed the test.

Comparative Tracking Index (CTI)—was expressed as that voltage which causes tracking after 50 drops of 0.1 percent ammonium chloride solution have fallen on the material. The results of testing the nominal 3 mm thickness were considered representative of the material's performance in any thickness. Since the target CTI requirement was 250 Volts, if a composition passed the 250 volts requirement by the method described as above, it was considered to have passed the CTI test. If it is not passing the test, it is deemed to have failed. Wherever possible, the test has been conducted at 400 volts and 600 volts as well. Similar pass/fail criterion was employed for those voltages as well.

Tensile Property Testing

Tensile properties were tested according to ISO 527 on 150×10×4×mm (length×wide×thickness) injection molded bars at 23° C. with a crosshead speed of 5 mm/min. Izod unnotched impact was measured at 23° C. with a pendulum of 5.5 Joule on 80×10×4 mm (length×wide×thickness) impact bars according to ISO 180 method. Flexural properties or three point bending were measured at 23° C. on 80×10×4 mm (length×wide×thickness) impact bars with a crosshead speed of 2 mm/min according to ISO 178.

In other cases, injection molded parts were tested by ASTM. Notched Izod testing was done on 3×½×⅛ inch bars using ASTM method D256. Tensile elongation at break was tested on 7×⅛ in. injection molded bars at room temperature with a crosshead speed of 2 in./min for glass filled samples and 0.2 in/min for un-filled samples by using ASTM D648. Flexural properties were measured using ASTM 790 or ISO 178 method.

Flame retardancy tests were performed following the procedure of Underwriter's Laboratory Bulletin 94 entitled “Tests for Flammability of Plastic Materials, UL94.” According to this procedure, materials may be classified as HB, V0, V1, V2, VA and/or VB on the basis of the test results obtained for five samples. To achieve a rating of V0, in a sample placed so that its long axis is 180 degrees to the flame, the average period of flaming and/or smoldering after removing the igniting flame does not exceed five seconds and none of the vertically placed samples produces drips of burning particles that ignite absorbent cotton. Five bar flame out time (FOT) is the sum of the flame out time for five bars, each lit twice for a maximum flame out time of 50 seconds. To achieve a rating of V1, in a sample placed so that its long axis is 180 degrees to the flame, the average period of flaming and/or smoldering after removing the igniting flame does not exceed twenty-five seconds and none of the vertically placed samples produces drips of burning particles that ignite absorbent cotton. Five bar flame out time is the sum of the flame out time for five bars, each lit twice for a maximum flame out time of 250 seconds. Compositions of this invention are expected to achieve a UL94 rating of V1 and/or V0 at a thickness of preferably lower than 1.5 mm and typically at 0.8 mm.

### Preparation of Molding Compositions: General Method

The materials used for the preparation of blends are given in the Table 1. The blends were obtained by mixing known amounts of polycarbonates, polyamide 6, polyethylene terephthalate, different FR additives and impact modifiers and other additives by weights as given in Table 2-5. The blending was carried out on a 37 mm Toshiba TEM-37BS co-rotating Twin Screw Extruder with a screw speed of about 300 rotation per minute. The final temperature employed during compounding was about 250 to 260° C. to form a melt. The melt was then extruded in the form of strand that was cooled through a water bath prior to pelletization. The pellets were dried for about −10 hours at about 120° C. in a forced air-circulating oven prior to molding. The samples were injection molded in 100 ton Injection Molding machine as per ASTM test protocol requirements. The temperature profile used for injection molding was 100-240-250-260-260° C.

TABLE 1
Raw Materials

| | | | |
|---|---|---|---|
| Item | Description | CAS# | Source |

Matrix Polymers

| | | | |
|---|---|---|---|
| PC | Polycarbonate high flow grade | 111211-39-3 | GE Plastics |
| PC | Polycarbonate of low flow grade | | |
| PET | PET (IV 0.64) | 25038-59-9 | Foshan |
| PA 6 | Nylon 6 | 25038-54-4 | DOMO |
| PBT | Polybutyleneterephthalate | 30965-26-5 | GE Plastics |

CARBOXY REACTIVE COMPONENTS

| | | | |
|---|---|---|---|
| CESA | Styrene-acrylate-epoxy oligomer | / | Johnson Polymer |
| LOTADER | E-GMA-MA | 51541-08-3 | PCT Atofina |

IMPACT MODIFIERS

| | | | |
|---|---|---|---|
| IM 2 | Methylmethacrylate Butadiene Styrene | — | ROHM & HASS |
| | copolymer | | |
| IM | ACRYLIC POLYMER IMPACT | 25852-37-3 | ROHM & HASS |
| | MODIFIER, PELLETS | | |

Flame retardants

| | | | |
|---|---|---|---|
| Br-FR-1 | Decabromodiphenylethane | 84852-53-9 | Chemtura |
| Br-Epoxy | BROMINATED EPOXY, NF 300 VLG | 68928-70-1 | Alteco chem |
| Br-FR-3 | 2,4,6-tribromophenol capped | 71342-77-3 | Great Lake |
| | TetraBromoBisPhenolA-carbonate oligomer | | |
| Br-PC | Brominated Polycarbonate | 156042-31-8 | GEP |
| Br-PS | Brominated Polystyrene | 88497-56-7 | Great Lake/ |
| | | | Albemarle |
| Br-Acrylic | Poly(pentabromobenzylacrylate) | 59447-57-3 | EUROBROMO |
| Br-FR-2 | 1,2-bis(tetrabromophthalimido)ethane | 32588-76-4 | Albemarle |

Other additives

| | | | |
|---|---|---|---|
| MZP | Mono zinc phosphate | 13598-37-3 | Siam Union |
| AO | Antioxidant 1010 | 6683-19-8 | CIBA |
| Sb₂O₃ MB | Sb₂O₃ PBT masterbatch | 1309-64-4 | GEP BOZ |
| LDPE | Low density polyethylene | 25087-34-7 | NOVA |
| | | | CHEMICALS |
| KSS | Potassium diphenylsulphone sulfonate | 63316-43-8 | Metropolitan |
| | | | Eximchem |
| Ultratalc | Ultratalc | 16389-88-1 | Cronell Bros |
| PETS | Pentaerythritol tetrastearate | 115-83-3 | Cognis |
| Teflon | Teflon powder | 9002-84-0 | Dupont |

TABLE 2

| | | | | |
|---|---|---|---|---|
| Item | Unit | C. Ex. 1 | C. Ex. 2 | Ex. 1 |

Matrix Resin

| | | | | |
|---|---|---|---|---|
| PA 6 | wt. % | 0.00 | 20.00 | 20.00 |
| PC* | wt. % | 28.00 | 18.00 | 28.00 |
| PET | wt. % | 57.02 | 47.02 | 37.12 |
| PA:(PC + PET) | none | 0.00 | 1:3.25 | 1:3.25 |
| PC:(PA + PET) | none | 1:2.04 | 1:3.72 | 1:2.04 |

Flame retardants

| | | | | |
|---|---|---|---|---|
| Br-FR-1 | wt. % | 5.00 | 5.00 | 5.00 |
| Br-Epoxy | wt. % | 2.00 | 2.00 | 2.00 |
| Bromine content | wt. % | 5.07 | 5.07 | 5.07 |
| CESA | wt. % | 0.10 | 0.10 | 0.10 |

Other Additives

| | | | | |
|---|---|---|---|---|
| MZP | wt. % | 0.02 | 0.02 | 0.02 |
| AO | wt. % | 0.06 | 0.06 | 0.06 |
| Sb₂O₃ MB | wt. % | 5.00 | 5.00 | 5.00 |
| LDPE | wt. % | 1.50 | 1.50 | 1.50 |
| KSS | wt. % | 0.20 | 0.20 | 0.20 |
| Ultratalc | wt. % | 0.50 | 0.50 | 0.50 |
| PETS | wt. % | 0.50 | 0.50 | 0.50 |
| Teflon | wt. % | 0.10 | 0.10 | 0.10 |

Performance characteristics

| | | | | |
|---|---|---|---|---|
| GWIT 1 mm (775 C.) | Pass/fail | Pass | Fail | Pass |
| GWIT 2 mm (775 C.) | Pass/fail | Pass | Fail | Pass |
| CTI 250 V | Pass/fail | fail | pass | pass |
| MVR at 265 C./2.16 | cc/10 min | 27.55 | 24.7 | 20.28 |
| Kg/240 s | | | | |
| Flexural Modulus | Mpa | 2420 | 2420 | 2390 |
| Flexural Strength-Y | Mpa | 96.2 | 97.8 | 96.3 |
| Flexural Strength-B | Mpa | 94.4 | 95.9 | 94.5 |
| IZOD-Notched | kJ/m2 | 34.782 | 30.43 | 34.266 |
| Tensile Moduls | Mpa | 2894 | 3054 | 3218 |
| Tensile Strength | MPa | 40.1 | 63.3 | 61.6 |
| Tensile Elongation | wt. % | 12 | 4.1 | 4.8 |
| Heat distortion temperature | deg C. | 119 | 127 | 125 |
| (0.45 mPa) | | | | |

*The ratio of high to low molecular weight polycarbonate employed is about 2.

From the results of Example 1 given in Table 2, satisfactory CTI and GWIT performances were obtained when a suitable combination of polycarbonate, polyethylene terephthalate and polyamide-6,6 was employed. Both CTI and GWIT requirements were passed when the ratio of PC (PA+PET) was 1:2.04 and PA:(PC+PET) ratio was 1:3.25.

When polyamide was absent (C. Ex. 1), the CTI requirement was not met. When the ratio of PC to (PA+PET) was 1:3.72 (C. Ex. 2), the composition did not pass the GWIT test (775 deg C., 2 mm).

TABLE 3
Effect of flame retardants

| | | | | | | | |
|---|---|---|---|---|---|---|---|
| Item | Unit | Ex. 2 | Ex. 3 | Ex. 4 | Ex. 5 | Ex. 6 | C. Ex. 3 |

Matrix Polymer

| | | | | | | | |
|---|---|---|---|---|---|---|---|
| PA 6 | wt. % | 20.00 | 20.00 | 20.00 | 20.00 | 20.00 | 20.00 |
| PC | wt. % | 28.00 | 28.00 | 28.00 | 28.00 | 28.00 | 20.00 |
| PET | wt. % | 36.92 | 36.35 | 36.35 | 36.35 | 35.18 | 30.79 |
| PA: (PC + PET) | none | 1:3.25 | 1:3.25 | 1:3.25 | 1:3.25 | 1:3.15 | 1:3.0 |
| PC: (PA + PET) | none | 1:2.04 | 1:2.01 | 1:2.01 | 1:2.01 | 1:1.97 | 1:2.54 |
| Flame Retardants | | | | | | | |
| Br-PC | wt. % | 0.00 | 0.00 | 0.00 | 0.00 | 0.00 | 21.13 |
| Br-PS | wt. % | 0.00 | 7.57 | 0.00 | 0.00 | 0.00 | 0.00 |
| Br-Acylic | wt. % | 0.00 | 0.00 | 7.57 | 0.00 | 0.00 | 0.00 |
| Br-FR 2 | wt. % | 0.00 | 0.00 | 0.00 | 7.57 | 0.00 | 0.00 |
| Br-FR 3 | wt. % | 0.00 | 0.00 | 0.00 | 0.00 | 8.74 | 0.00 |
| Br-FR-1 | wt. % | 5.00 | 0.00 | 0.00 | 0.00 | 0.00 | 0.00 |
| Br-Epoxy | wt. % | 2.00 | 0.00 | 0.00 | 0.00 | 0.00 | 0.00 |
| Bromine content | wt. % | 5.06 | 5.07 | 5.07 | 5.07 | 5.07 | 5.07 |
| in formulation | | | | | | | |
| CESA | wt. % | 0.10 | 0.10 | 0.10 | 0.10 | 0.10 | 0.10 |
| Other Additives | | | | | | | |
| MZP | wt. % | 0.02 | 0.02 | 0.02 | 0.02 | 0.02 | 0.02 |
| AO | wt. % | 0.06 | 0.06 | 0.06 | 0.06 | 0.06 | 0.06 |
| Sb₂O₃ MB | wt. % | 5.00 | 5.00 | 5.00 | 5.00 | 5.00 | 5.00 |
| LDPE | wt. % | 1.50 | 1.50 | 1.50 | 1.50 | 1.50 | 1.50 |
| KSS | wt. % | 0.20 | 0.20 | 0.20 | 0.20 | 0.20 | 0.20 |
| Ultratalc | wt. % | 0.50 | 0.50 | 0.50 | 0.50 | 0.50 | 0.50 |
| PETS | wt. % | 0.50 | 0.50 | 0.50 | 0.50 | 0.50 | 0.50 |
| Teflon | wt. % | 0.20 | 0.20 | 0.20 | 0.20 | 0.20 | 0.20 |

Performance Characteristics

| | | | | | | | |
|---|---|---|---|---|---|---|---|
| GWIT 1 mm 775 C. | Pass/Fail | Pass | Pass | Pass | Pass | Pass | Pass |
| GWIT 2 mm 775 C. | Pass/Fail | Pass | Pass | Pass | Pass | Pass | Pass |
| CTI 250 V | Pass/Fail | Pass | Pass | Pass | Pass | Pass | Fail |
| IZOD-Notched | kJ/m2 | 28.6 | 17.7 | 22.6 | 20.5 | 26.5 | 33.3 |
| Flexural | Mpa | 2210 | 2220 | 2250 | 2470 | 2400 | 2330 |
| Modulus | | | | | | | |
| Flexural | Mpa | 88.4 | 91.8 | 92.2 | 94.8 | 95.6 | 95.7 |
| Strength-B | | | | | | | |
| Heat Distortion | C. | 105 | 103 | 105 | 104 | 107 | 112 |
| Temperature- | | | | | | | |
| HDT (1.82 Mpa) | | | | | | | |
| Tensile Modulus | Mpa | 2692 | 2848 | 2882 | 3042 | 2786 | 2660 |
| Tensile Strength | Mpa | 39.3 | 49.8 | 54.6 | 60.7 | 59.3 | 29.7 |
| Tensile | wt. % | 7.9 | 2.7 | 3.3 | 3.8 | 4.0 | 22 |
| Elongation | | | | | | | |
| MVR at 265 C./ | cc/10 min | 16.77 | 16.66 | 18.65 | 21.48 | 22.12 | 19.64 |
| 2.16 Kg/240 s | | | | | | | |

As seen in Table 3, acceptable results of GWIT and CTI were obtained with a wide variety of brominated flame-retardants. When a brominated oligocarbonate of 50 wt. % bromine content (Example 6) is used, the composition passed both CTI and GWIT requirements. However, a composition with brominated polycarbonate at the indicated amount did not pass the CTI test (See C. Ex. 3).

TABLE 4

| Description | Unit | Ex. 9 | Ex. 10 | Ex. 11 | Ex. 12 | Ex. 13 | Ex. 14 | Ex. 15 | Ex. 16 | Ex. 17 |
|---|---|---|---|---|---|---|---|---|---|---|
| Nylon 6 | wt. % | 20.00 | 10 | 15 | 20 | 10 | 15 | 20 | 10 | 20 |
| PCP1300 | wt. % | 10.00 | 10.00 | 10.00 | 10.00 | 10.00 | 10.00 | 10.00 | 10.00 | 10.00 |
| 100 Grade PCP | wt. % | 18.00 | 22.00 | 18.00 | 18.00 | 20.00 | 18.00 | 15.00 | 18.00 | 13.00 |
| PET | wt. % | 36.92 | 40.92 | 39.92 | 34.92 | 38.92 | 35.92 | 33.92 | 36.92 | 31.92 |
| PC/(PET + PA) | — | 1:2.03 | 1:1.59 | 1:1.96 | 1:1.96 | 1:1.63 | 1:1.82 | 1:2.16 | 1:1.68 | 1:2.26 |
| PA/(PET + PC) | — | 1:3.25 | 1:7.29 | 1:4.53 | 1:3.15 | 1:6.89 | 1:4.26 | 1:2.95 | 1:6.49 | 1:2.75 |
| LOTADER | wt. % | 0.00 | 2 | 2 | 2 | 6 | 6 | 6 | 10 | 10 |
| AX8900 | | | | | | | | | | |
| CESA | wt. % | 0.10 | 0.10 | 0.10 | 0.10 | 0.10 | 0.10 | 0.10 | 0.10 | 0.10 |

Flame retardants

| | | | | | | | | | | |
|---|---|---|---|---|---|---|---|---|---|---|
| Br-FR-1 | wt. % | 5.00 | 5.00 | 5.00 | 5.00 | 5.00 | 5.00 | 5.00 | 5.00 | 5.00 |
| Br-epoxy | wt. % | 2.00 | 2.00 | 2.00 | 2.00 | 2.00 | 2.00 | 2.00 | 2.00 | 2.00 |
| Final Bromine | wt. % | 5.07 | 5.07 | 5.07 | 5.07 | 5.07 | 5.07 | 5.07 | 5.07 | 5.07 |
| content in formula | | | | | | | | | | |

Other Additives

| | | | | | | | | | | |
|---|---|---|---|---|---|---|---|---|---|---|
| MZP | wt. % | 0.02 | 0.02 | 0.02 | 0.02 | 0.02 | 0.02 | 0.02 | 0.02 | 0.02 |
| Antioxidant 1010 | wt. % | 0.06 | 0.06 | 0.06 | 0.06 | 0.06 | 0.06 | 0.06 | 0.06 | 0.06 |
| Sb₂O₃, MB | wt. % | 5.00 | 5.00 | 5.00 | 5.00 | 5.00 | 5.00 | 5.00 | 5.00 | 5.00 |
| LLDPE | wt. % | 1.50 | 1.50 | 1.50 | 1.50 | 1.50 | 1.50 | 1.50 | 1.50 | 1.50 |
| KSS | wt. % | 0.20 | 0.20 | 0.20 | 0.20 | 0.20 | 0.20 | 0.20 | 0.20 | 0.20 |
| Ultratalc 609 | wt. % | 0.50 | 0.50 | 0.50 | 0.50 | 0.50 | 0.50 | 0.50 | 0.50 | 0.50 |
| PETS | wt. % | 0.50 | 0.50 | 0.50 | 0.50 | 0.50 | 0.50 | 0.50 | 0.50 | 0.50 |
| PTFE powder | wt. % | 0.20 | 0.20 | 0.20 | 0.20 | 0.20 | 0.20 | 0.20 | 0.20 | 0.20 |

Performance characteristics

| | | | | | | | | | | |
|---|---|---|---|---|---|---|---|---|---|---|
| CTI 250 V | Pass/fail | Pass | Pass | Pass | Pass | Pass | Pass | Pass | Pass | Pass |
| GWIT, 1 mm at 775 C. | Pass/fail | Pass | Pass | Pass | Pass | Pass | Pass | Pass | Pass | Pass |
| GWIT, 2 mm at 775 C. | Pass/fail | Pass | Pass | Pass | Pass | Pass | Pass | Pass | Pass | Pass |

As seen from Table 4, the presence of impact modifiers did not affect the GWIT/CTI balance of the inventive compositions. When the impact modifier was greater than about 6%, the mechanical properties, particularly tensile modulus became lower by greater than about 25% of the original tensile modulus value and hence considered unsuitable in some connector applications. Generally, a good balance of GWIT and CTI requirement is met when the ratio of PA:(PET+PC) is in the range of 1:1.0 to 1:15 and the ratio of PC (PET+PA) is in the range of 1:0.7 to 1:3.3

TABLE 5

| | | | |
|---|---|---|---|
| Ingredients | Unit | Ex. 18 | Ex. 19 |

Matrix polymer

| | | | |
|---|---|---|---|
| PA 6 | wt. % | 15 | 15 |
| PC | wt. % | 10.00 | 10.00 |
| PC | wt. % | 18.00 | 18.00 |
| PET | wt. % | 39.32 | 34.32 |
| PET/PC ratio | — | 1.40 | 1.23 |
| PA:(PET + PC) | — | 1:4.49 | 1:4.15 |
| LOTADER | wt. % | 2 | 2 |
| CESA | wt. % | 0.10 | 0.10 |

Impact modifier

| | | | |
|---|---|---|---|
| IM | wt. % | 0.00 | 5.00 |

Flame retardants

| | | | |
|---|---|---|---|
| Br-FR-1 | wt. % | 5.60 | 5.60 |
| Br-Epoxy | wt. % | 2.00 | 2.00 |

Other Additives

| | | | |
|---|---|---|---|
| MZP | wt. % | 0.02 | 0.02 |
| AO | wt. % | 0.06 | 0.06 |
| Sb₂O₃ MB | wt. % | 5.00 | 5.00 |
| LDPE | wt. % | 1.50 | 1.50 |
| KSS | wt. % | 0.20 | 0.20 |
| Ultratalc | wt. % | 0.50 | 0.50 |
| PETS | wt. % | 0.50 | 0.50 |
| Teflon | wt. % | 0.20 | 0.20 |

Performance characteristics

| | | | |
|---|---|---|---|
| GWIT 1 mm, 775 C. | pass/fail | pass | pass |
| GWIT 2 mm, 775 C. | pass/fail | pass | pass |
| CTI 250 V | pass/fail | pass | pass |
| V-0 @0.83 mm | pass/fail | pass | pass |
| IZOD-N | J/N | 31.7 | 52.4 |

As seen in Table 5, the formulations of the invention exhibited excellent flame retardant ratings (UL-94). When an acrylic impact modifier was present along with LOTADER (E/GMA/MA terpolymer), the notched Izod impact property was improved.

### Comparative Example 4

The procedure of Example 10 was followed except that the amount of polyamide amount was 5 wt %. The results obtained indicated that the composition did not impart an acceptable GWIT rating.

### Example 20

The procedure of Example 1 was repeated, except that the following formulation was used, as shown in Table 6:

TABLE 6

| Description | Unit | Ex. 20 |
|---|---|---|
| Nylon 6 | wt. % | 5 |
| LOTADER AX8900 | wt. % | 2 |
| PET | wt. % | 21.2 |
| PC/(PET + PA) | — | 1.9 |
| PA/(PFT + PC) | — | 0.07 |
| CESA | wt. % | 0.1 |
| Br-FR-1 | wt. % | 8.5 |
| Final Bromine content in formula | wt. % | 5.7 |
| MZP | wt. % | |
| Antioxidant 1010 | wt. % | 0.1 |
| Sb₂O₃, MB | wt. % | 6.7 |
| LLDPE | wt. % | 0.5 |
| KSS | wt. % | / |
| Ultratalc 609 | wt. % | 0.5 |
| PETS | wt. % | 0.2 |
| TSAN | wt. % | 0.2 |

### Results

The results of the tests for this formulation indicated that the composition passed the following tests, as shown in Table 7:

TABLE 7

| | | |
|---|---|---|
| CTI 250 V | Pass/fail | Pass |
| GWIT, 1 mm at 775 C. | Pass/fail | Pass |
| GWIT, 2 mm at 775 C. | Pass/fail | Pass |

Although the present invention has been described in detail with reference to certain preferred versions thereof, other variations are possible. Therefore, the spirit and scope of the appended claims should not be limited to the description of the versions contained therein.

What is claimed is:

1. A molding composition comprising:
(a) a polycarbonate component;
(b) a polyester component;
(c) a polyamide component;
(d) a halogenated flame retarding component; and
(e) at least one carboxy reactive component;
wherein the polycarbonate component, the polyester component, the polyamide component, and the halogenated flame retarding component, and the carboxy reactive component are present in sufficient amounts to impart (i) a Glow Wire Ignition Temperature that is at least 775° C. and (ii) a Comparative Tracking Index that is at least 250 V to a member selected from the group consisting of the composition, an article molded from the composition, an article extruded from the composition, and combinations thereof.

2. The composition of claim 1, wherein the polycarbonate component, the polyester component, the polyamide component, the halogenated flame retarding component and the carboxy reactive component are present in sufficient amounts to impart a flame retardance rating of V0, as per UL 94, to a member selected from the group consisting of the composition, an article molded from the composition, an article extruded from the composition, and combinations thereof.

3. The composition of claim 1, wherein the polycarbonate component is present in an amount ranging from 15 to 50 wt %.

4. The composition of claim 1, wherein the polyester component is selected from the group consisting of polyethylene terephthalate, and poly(1,4-butylene terephthalate, poly(butylene naphthanoate), poly(cyclohexanedimethylene terephthalate, polycyclohexylenedimethylene ethylene terephthalate, polypropylene terephthalate, and combinations thereof.

5. The composition of claim 1, wherein the polyester component is present in an amount ranging from 20 to 40 wt %.

6. The composition of claim 1, wherein the polyamide component is selected from the group consisting of Nylon-6 and Nylon-6,6 Nylon-4,6, Nylon-12, Nylon-6,10, Nylon-6,9, Nylon-6/6T, Nylon-6,6/6T, polycaproamide, polyhexamethylene adipamide, polyhexathylene sebacamide, polyundecamethylene adipamide, polyundecanamide, polydodecanamide copolymerized polyamides of the foregoing, and combinations thereof.

7. The composition of claim 1, wherein the polyamide component is present in an amount ranging from more than 5 to 30 wt %.

8. The composition of claim 1, wherein the halogenated flame retarding component is selected from the group consisting of ethane-1,2-bis[pentabromophenyl, brominated polystyrene, poly(pentabromobenzylacrylate), 1,2-bis-(tetrabromophthalimido)ethane, phenol-capped carbonate pentamers of TetraBromoBis PhenolA-carbonate oligomers, 2,4,6-tribromophenol capped TetraBromoBis PhenolA-carbonate oligomers, brominated polycarbonates, tetrabromo bisphenol a diglycidyl ether, and combinations thereof.

9. The composition of claim 1, wherein the halogenated fire retarding component is present in an amount ranging from 5 to 15 wt %.

10. The composition of claim 1, wherein the halogenated fire retarding component further comprises flame retarding synergists selected from the group of antimony trioxide, Sb₂O₃, antimony pentoxide Sb₂O₅, sodium antimonite, and combinations thereof in an amount ranging from 2 to 7 wt %.

11. The composition of claim 1, wherein the composition further comprises at least one impact modifier.

12. The composition of claim 1, wherein the carboxy reactive component is selected from the group consisting of polymeric polyfunctional carboxy reactive materials, non-polymeric carboxy reactive materials, and combinations thereof.

13. The composition of claim 1, wherein the carboxy reactive component is selected from the group consisting of epoxides, carbodiimides, orthoesters, oxazolines, oxiranes, aziridines, anhydrides, reactive silicone containing materials of the foregoing, and combinations thereof.

14. The composition of claim 13, wherein the carboxy reactive component is a co- or ter-polymer including units of ethylene and glycidyl methacrylate.

15. The composition of claim 13, wherein the carboxy reactive component is present in an amount that is at least 0.01 wt. %.

16. A composition of matter comprising an article derived from a composition comprising:
(a) a polycarbonate component;
(b) a polyester component;
(c) a polyamide component;
(d) a halogenated flame retarding component;
(e) at least one carboxy reactive component;
(f) at least one impact modifier
wherein the polycarbonate component, the polyester component, the polyamide component, the halogenated flame retarding component, and the carboxy reactive component, and the impact modifier are present in sufficient amounts to impart a Glow Wire Ignition Temperature that is at least 775° C., a flame retardance rating of V0, as per UL 94 and a Comparative Tracking Index that is at least 250 V to the article.

17. The composition of matter of claim 16, wherein the article is selected from the group consisting of relay housing controls, timer housing structures, connectors, controls, switches, and combinations thereof.

18. The composition of matter of claim 16, wherein the polycarbonate component is present in an amount ranging from 15 to 55 wt %, the polyester component is present in an amount ranging from 20 to 40 wt %, the polyamide component is present in an amount ranging in an amount ranging from 10 to 30 wt %, the halogenated flame retarding component is present in an amount ranging from 5 to 15 wt. %, the carboxy reactive component is present in an amount ranging from 1 to 10 wt % and the impact modifier is present in an amount ranging from 1 to 10%;
wherein the sum of the wt % of the polycarbonate, the polyester component, the polyamide component, the halogenated flame retarding component, the carboxy reactive component, and the impact modifier is 100 wt %.

19. The composition of matter of claim 17, wherein the polycarbonate component is present in an amount ranging from 15 to 45 wt %, the polyester component is present in an amount ranging from 20 to 40 wt %, the polyamide component is present in an amount ranging in an amount ranging from 10 to 30 wt %, the halogenated flame retarding component is present in an amount ranging from 5 to 15 wt. %, the carboxy reactive component is present in an amount ranging from 1 to 10 wt %;
wherein the sum of the polycarbonate, the polyester component, the polyamide component, the halogenated flame retarding component, the carboxy reactive component, and the impact modifier is 100 wt %.

20. A composition comprising:
(a) from 15 to 40 wt % of a polycarbonate component;
(b) from 20 to 40 wt % of a polyester component;
(c) from more than 5 to 30 wt % of a polyamide component;
(d) from 5 to 15 wt % of a halogenated flame retarding component;
(e) at least 0.1 wt. % of a carboxy reactive component
(f) from 0 to 7 wt % of a flame retarding synergist selected from the group consisting of antimony trioxide, Sb₂O₃, antimony pentoxide Sb₂O₅, sodium antimonate, and combinations thereof,
wherein the sum of (a), (b), (c), (d), (e) and (f) is 100 wt %.

21. A composition comprising:
(a) from 40 to 55 wt % of a polycarbonate component;
(b) from 20 to 40 wt % of polyethylene terephthalate;
(c) from 2 to 7 wt % of a polyamide component;
(d) from 5 to 15 wt % of a halogenated flame retarding component;
(e) from 1 to 3 wt. % of a carboxy reactive component
(f) from 3 to 7 wt % of a flame retarding synergist selected from the group consisting of antimony trioxide, Sb₂O₃, antimony pentoxide Sb₂O₅, sodium antimonate, and combinations thereof,
(g) an impact modifier selected from the group consisting of acrylic pellets.
(h) a mold release agent selected from the group consisting hydrocarbon mold-release agents, fatty acids, aliphatic alcohols, polyhydric alcohols, polyglycols, polyglycerols, butyl stearate, pentaerythritol tetrastearate, and combination thereof;
(i) from 1 to 5 wt % of an additive selected from the group consisting of talc, hindered phenol stabilizers, poly(tetrafluoroethylene):styrene-acrylonile, and combinations thereof;
wherein the sum of (a), (b), (c), (d), (e), (f), (g), (h), and (i) is 100 wt %; and
wherein the polycarbonate component, the polyester component, the polyamide component, and the halogenated flame retarding component, and the carboxy reactive component are present in sufficient amounts to impart (i) a Glow Wire Ignition Temperature that is at least 775° C. and (ii) a Comparative Tracking Index that is at least 250 V to a member selected from the group consisting of the composition, an article molded from the composition, an article extruded from the composition, and combinations thereof.

22. The composition of claim 21, wherein the halogenated flame retarding agent is brominated polystyrene.

23. The composition of claim 1, wherein the composition imparts a Glow Wire Ignition Temperature that is at least 775° C. to the member at a thickness selected from the group consisting of 1 mm, 2 mm, and combinations thereof and (ii) a Comparative Tracking Index that is at least 250 V at a thickness of 3 mm.

24. The composition of claim 2, wherein the wherein the polycarbonate component, the polyester component, the polyamide component, the halogenated flame retarding component and the carboxy reactive component are present in sufficient amounts to impart, to the member a flame retardance rating of V0 at a thickness of 0.83 mm, as per UL 94.

25. The composition of matter of claim 16, wherein the composition impartsto the member a Glow Wire Ignition Temperature that is at least 775° C. at a thickness selected from the group consisting of 1 mm, 2 mm, and combinations thereof and (ii) a Comparative Tracking Index that is at least 250 V at a thickness of 3 mm to the member and (iii) a flame retardance rating of V0 at a thickness of 0.83 mm, as per UL 94.

26. The composition of matter of claim 20, wherein the composition imparts to the member a Glow Wire Ignition Temperature that is at least 775° C. at a thickness selected from the group consisting of 1 mm, 2 mm, and combinations thereof and (ii) a Comparative Tracking Index that is at least 250 V at a thickness of 3 mm to the member and (iii) a flame retardance rating of V0 at a thickness of 0.83 mm, as per UL 94.

27. The composition of matter of claim 21, wherein the composition imparts to the member a Glow Wire Ignition Temperature that is at least 775° C. at a thickness selected from the group consisting of 1 mm, 2 mm, and combinations thereof and (ii) a Comparative Tracking Index that is at least 250 V at a thickness of 3 mm and (iii) a flame retardance rating of V0 at a thickness of 0.83 mm, as per UL 94.
